(19) United States
(12) Patent Application Publication
(10) Pub. No.: US 2017/0030418 A1
(43) Pub. Date: Feb. 2, 2017

(54) DIRECTLY ACTUATABLE CLUTCH WITH VENTILATION GEOMETRY

(71) Applicant: SCHAEFFLER TECHNOLOGIES AG & CO. KG, Herzogenaurach (DE)

(72) Inventors: Rene Hellgoth, Lichtenau (DE); René Daikeler, Sasbach (DE)

(21) Appl. No.: 15/301,744

(22) PCT Filed: Mar. 19, 2015
(86) PCT No.: PCT/DE2015/200170

§ 371 Date: Oct. 4, 2016

(30) Foreign Application Priority Data
Apr. 4, 2014 (DE) 10 2014 206 490.2

(51) Int. Cl. F16D 13/72; F16D 13/38; F16D 13/70

(52) U.S. Cl. CPC F16D 13/72; F16D 13/70; F16D 13/385; F16D 2250/0023; F16D 2200/0004; F16D 2021/0615

(57) ABSTRACT

The invention relates to a friction clutch for a drivetrain of a motor vehicle, having a contact plate that is movable relative to a pressure plate and a clutch disk to engage and disengage the clutch, and having an actuating element that influences the contact plate displacement position and is non-rotatably connected to the contact plate. The actuating element has at least one fluid diverting section which, in an operating state of the clutch, introduces a cooling fluid into the interior of the clutch to cool the contact plate, pressure plate, and/or clutch disk. The actuating element is preferably designed as a rigid component and for a system consisting of such a friction clutch and a transmission bell housing.

### CROSS-REFERENCE TO RELATED APPLICATIONS

The present application is the United States National Stage Application pursuant to 35 U.S.C. §371 of International Patent Application No. PCT/DE2015/200170, filed on Mar. 19, 2015, and claims priority to German Patent Application No. DE 10 2014 206 490.2 of Apr. 4, 2014, which applications are incorporated by reference in their entireties.

### FIELD

The invention relates to a (preferably directly actuatable) friction clutch/friction clutch for a drivetrain of a motor vehicle, such as an automobile, truck, bus or agricultural utility vehicle, and more particularly, to a friction clutch having an actuating element with a fluid diverting section which, in an operating state of the clutch, introduces a cooling fluid into the interior of the clutch.

### BACKGROUND

Directly actuated clutches, for example directly actuatable dual clutches, are already known in the art. For example, DE 10 2011 013 475 A1 discloses a dual clutch having a first and a second spring element, wherein the first spring element is positioned at least partially, preferably completely, radially within a radially outer edge of a first friction zone and/or the second spring element is positioned at least partially, preferably completely, radially within a radially outer edge of a second friction zone. This dual clutch is distinguished by the so-called four-plate design; that is, each clutch of the dual clutch has its individually assigned contact plate and counterplate/pressure plate.

Furthermore, fluid diverting sections in dry clutches are also already known, as disclosed for example in DE 36 02 716 A1. This friction clutch is designed as a dry single clutch, and has a component with air guide vanes mounted separately on the housing. A comparable design of a friction clutch is disclosed in DE 33 04 670 A1.

Another fan geometry as a fluid redirection section and as an integral part of a flywheel or of a counterplate/pressure plate is disclosed in DE 101 10 897 A1.

In addition, devices and their use to operate a motor vehicle are disclosed in DE 103 38 558 A1, wherein a dual clutch transmission having cooling ducts on the pressure plate and on the flywheel is disclosed in connection with FIGS. 44 through 48, and 55.

Moreover, a dual friction clutch for tractors, implement carriers, and similar vehicles is disclosed by DE 1 294 228, wherein a clutch disk of a power take-off shaft is provided with fan blades (or is bent out from the interior of the clutch disk).

Thus, it can be stated in summary that there are already dual clutches known from the prior art wherein an air eddy that occurs in pairs is produced when these clutches are operated. This air eddy tends to result in cooling of the friction surfaces of the thermal masses, i.e., of the contact plate, the pressure plate, and/or the clutch disk, and a removal of a certain quantity of thermal energy. Abrasion debris from the area of the friction surfaces/friction contacts may also be removed by this air eddy. The actuating elements in the form of diaphragm springs are at the same time especially predestined to form fluid redirection sections, since they are located in an area axially distant from the combustion engine next to the friction surfaces of the pressure plates, the contact plates, and the clutch disks, and therefore can introduce cooling fluid from a cooler region of the clutch in the direction of the pressure plates, clutch disks, and contact plates.

Production of these already known clutches is relatively complex however, and consequently cost-intensive. Actuating elements with fluid diverting sections known in the art are designed as diaphragm springs and, because of their relatively complex geometry and operating principle, are therefore often designed as heat-treated, hardened components which move rapidly back and forth between two positions when the clutch is actuated. However, the production of these diaphragm springs, particularly the diaphragm spring tongues, by means of multiple machining steps, involves a relatively great expense. The fluid diverting sections themselves are therefore also expensive to form. Due to the material properties of the hardened diaphragm springs, large shaping radii are only possible under certain circumstances, since material damage must be avoided. In addition, these known diaphragm springs change their oblique position when moving from the engaged to the disengaged position, which is a disadvantage. This also changes the relative position of the fluid diverting sections relative to the thermal masses being cooled, and the path of the cooling fluid flow is also changed during the operation.

### SUMMARY

The object of the present invention is therefore to remedy the disadvantages known in the art, and also to make directly actuatable clutches available with a reduced production expense and an improved delivery of coolant.

This is fulfilled, according to the invention, by designing the actuating element as a rigid component (i.e., dimensionally stable/not elastically deformable under normally occurring operating conditions).

This rigid design has the advantage, compared to the flexible geometry of the diaphragm spring, which changes when switching between the engaged and disengaged positions, that the inclination of the actuating element does not change when switching between the engaged and disengaged positions. This makes it possible now to always introduce the cooling fluid specifically into a particular region in the interior of the clutch, in particular in the axial direction, during operation of the combustion engine, thereby enabling a reproducible flow of cooling fluid within the clutch. The cooling fluid can thereby be directed optimally to the pressure plate, the contact plate, and/or the clutch disk, further increasing the cooling capacity. In addition, since the actuating element is designed to be rigid, it is also possible to produce it inexpensively. The actuating element is preferably formed from a less hard/low-hardness metal material, which simplifies the production of the fluid diverting sections and makes the friction clutches less expensive to produce.

So, according to another embodiment, it is advantageous if the actuating element is designed as a cup-shaped load transfer plate, which preferably acts with a first region on the contact plate (at least in an engaged position), and is actuatable by means of a slave cylinder with a second region which is located further inward in the radial direction compared to the first region (relative to the axis of rotation of the clutch). Such an actuating pot may be produced, for example, by a deep drawing process, for example from sheet metal, which makes the production even more inexpensive. This cup-shaped load transfer plate is preferably mounted so that it is movable in the axial direction, to shift the contact plate.

If the actuating element is preferably produced from a cold-formable metal material, preferably a steel or aluminum alloy, the fluid diverting sections can be produced inexpensively by means of known reshaping and/or stamping techniques.

In addition, if the actuating element is executed as a sheet metal part from the metal material, the production is simplified further.

Furthermore, it is also expedient if the at least one fluid diverting section has a diverting blade/scoop/vane geometry which is executed integrally with the actuating element, where the diverting blade/scoop/vane geometry is produced by a reshaping process, preferably by a cold-forming process and/or by a stamping process. This enables the fluid diverting section to be shaped by means of the fewest possible production steps. To form the fluid diverting section, preferably an area of the actuating element is first deep drawn, and then an opening is made in a section of this deep drawn area by means of a stamping process, which produces a through hole between the two axial sides of the actuating element. It is also possible, according to an especially preferred design, to first make an opening in the actuating element, for example by means of a stamping process, and then to deep draw/cold form an edge zone of this opening and thereby form the diverting blade.

In addition, it is beneficial if at least the pressure plate or the contact plate has, in the area of a friction surface which is connected (frictionally) with the clutch disk in the engaged position, a groove geometry which is arranged to distribute the cooling fluid, in particular in the radial direction. These groove geometries may be designed, for example, as grooves extending essentially in the radial direction, which ensure that the cooling fluid can be carried on outward in the radial direction even in the engaged position, i.e., when the friction surfaces of the pressure plate and contact plate are in contact with the clutch disk. This further improves the cooling capacity.

It is also beneficial if at least the pressure plate or the contact plate (or a flywheel which is non-rotatably connected to the pressure plate) has at least one fluid diverting section which diverts the cooling fluid, and/or for both the pressure plate and the contact plate to have at least one fluid diverting section which diverts the cooling fluid. The second diverting section may again have a diverting blade/scoop/blade geometry and serve to guide the cooling fluid further. An especially precise introduction of the cooling fluid into the friction surfaces between the pressure plate and contact plate, and the clutch disk is possible as a result. The cooling capacity can be further improved thereby.

Also, a particular efficient design can be achieved if the friction clutch is designed as a dual clutch having two partial clutches, with an actuating element being provided for each partial clutch.

In this connection, it is especially beneficial if a first actuating element of a first partial clutch and a second actuating element of a second partial clutch each have at least one fluid diverting section, with part of the first actuating element extending radially outside of the second actuating element. This makes it possible for the cooling fluid to be guided from the first actuating element specifically in the direction of the second actuating element and, for the supply of the cooling fluid to already be redirected radially inward, the cooling fluid can then be guided specifically to the corresponding pressure, contact, and clutch disks. This further improves the cooling of the clutch.

In addition, it is also beneficial if the friction clutch is designed as a dry-running friction clutch, in which case an especially large quantity of heat can then be removed quickly by the stream of cooling fluid (cooling air) that is produced.

In addition, a system consisting of a friction clutch and a transmission bell housing is also provided, wherein the friction clutch is designed according to at least one of the embodiments named above, and wherein the bell housing located adjacent to the friction clutch is designed with a plurality of ribs that drive and/or divert the cooling fluid (and that preferably extend in the radial direction). Cooling fluid is transported additionally by these ribs through the bell housing in the direction of the actuating elements, making an even better-directed and stronger configuration of the cooling fluid stream possible.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a longitudinal sectional view of a first embodiment of a friction clutch according to the invention designed as a dual clutch, with the sectional view of the friction clutch being taken in an area in which there is a fluid diverting section in each of the two actuating elements of the friction clutch;

FIG. 2 is a geometric depiction of a partial circular segment of an actuating element of the friction clutch according to the invention shown in FIG. 1, wherein, in particular, the design of the at least one fluid diverting section is visible; and,

FIG. 3 is a longitudinal view of a second embodiment of a friction clutch according to the invention designed as a dual clutch, wherein a contact plate of the second partial clutch now has a groove geometry, and a stream of cooling fluid carried through this groove geometry is sketched in.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

FIG. 1 shows a first embodiment of friction clutch 1, according to the invention. Friction clutch 1 is designed for a drivetrain of a motor vehicle, for example an automobile, truck, bus, or agricultural utility vehicle, and serves as a separable torque transmission device for transferring torque between a combustion engine, for example a gasoline or diesel engine, and a transmission. In this case, friction clutch 1 is designed as a dry-running friction clutch, but may alternatively be designed as a wet-running friction clutch. Friction clutch 1 is also designed and functions as a dual clutch, as already known essentially from DE 10 2011 013 475 A1. The disclosure content of DE 10 2011 013 475 A1 is therefore to be considered as integrated herein.

The friction clutch 1 has, in principle, contact plate 6, 7, which is movable back and forth relative to pressure plate 2, 3 and clutch disk 4, 5 to engage and disengage clutch 1.

Furthermore, friction clutch 1 also comprises actuating element 8, 9 which influences the contact plate displacement position and is non-rotatably connected to contact plate 6, 7. Actuating element 8, 9 comprises at least one fluid diverting section 10, which introduces a cooling fluid into the interior of clutch 1 to cool contact plate 6, 7, pressure plate 2, 3, and/or clutch disk 4, 5 in an operating state of clutch 1, namely when the combustion engine is turned on.

As can also be seen in FIG. 1, since friction clutch 1 is designed as a dual clutch, friction clutch 1 has partial clutches 11 and 12 which are separate from each other. First partial clutch 11 has first pressure plate 2, which in turn is non-rotatably connected to a crankshaft of the combustion engine by means of torsional vibration damper 13 in the form of a dual-mass flywheel, first clutch disk 4, which in turn is non-rotatably connected to first transmission input shaft 14, and first contact plate 6, which is movable in the axial direction (i.e., along clutch rotation axis 15) of friction clutch 1. First contact plate 6 in turn is non-rotatably connected to first pressure plate 2 and is movable relative to the latter in the axial direction. First clutch disk 4 is also mounted so that it is movable in the axial direction, and can be shifted in the axial direction relative both to first contact plate 6 and to first pressure plate 2.

When first partial clutch 11 is in an engaged position, first contact plate 6 is in frictional contact with first clutch disk 4 and first pressure plate 2, in such a way that first pressure plate 2 is non-rotatably connected to first clutch disk 4. In this engaged position, first contact plate 6, first clutch disk 4 and first pressure plate 2 are in frictional contact with each other by means of their friction surfaces. Also in the engaged position, first contact plate 6 presses first clutch disk 4 in the direction of first pressure plate 2 in order to non-rotatably connect first clutch disk 4 and first pressure plate 2.

In a disengaged position of first partial clutch 11, first contact plate 6 in turn is spaced apart from first clutch disk 4, which brings about a release of first pressure plate 2 from first clutch disk 4, and as a result, no torque is transmitted between first pressure plate 2 and first clutch disk 4.

First actuating element 8 is provided for moving first contact plate 6 between the engaged position and the disengaged position. First actuating element 8 is designed as a cup-shaped load transfer plate and is mounted so that it is movable in the axial direction, but at the same time is also non-rotatably connected to first contact plate 6. First actuating element 8 is rigidly designed/formed rigidly, that is, as a rigid and dimensionally stable component, and while moving between the engaged and disengaged positions is not subject to any noticeable elastic deformations that would lead to tipping/twisting or shifting of fluid diverting section 10 in the radial direction.

Second partial clutch 12 of the dual clutch in turn is designed and functions in accordance with first partial clutch 11. Second partial clutch 12 has clutch disk 5, referred to below as second clutch disk 5, pressure plate 3, referred to below as second pressure plate 3, contact plate 7, referred to below as second contact plate 7, and actuating element 9, referred to below as second actuating element 9.

Like second contact plate 7, second pressure plate 3 is non-rotatably connected to first pressure plate 2. Second contact plate 7 is mounted so that it is movable in the axial direction relative to second clutch disk 5 and second pressure plate 3. Also, second clutch disk 5 is positioned between second pressure plate 3 and second contact plate 7 in the axial direction, and is movable in the axial direction relative to second pressure plate 3 and second contact plate 7. The displacement position of second contact plate 7 is determined in turn by means of second actuating element 9, which second actuating element 9 is likewise designed as a cup-shaped load transfer plate.

When second partial clutch 12 is in an engaged position, second actuating element 9 presses against second contact plate 7 in such a way that the latter is pushed in the direction of second clutch disk 5 and against second pressure plate 3. When second partial clutch 12 is in the engaged position, second contact plate 7 is in frictional contact with second clutch disk 5 and with second pressure plate 3, in such a way that second pressure plate 3 is non-rotatably connected to second clutch disk 5. In the engaged position, second contact plate 7, second clutch disk 5, and second pressure plate 3 are in frictional contact with each other by means of their friction surfaces. Second clutch disk 5 in turn is connectible to second transmission input shaft 16 of a transmission, not shown here in further detail, and is also connected to it in the operating state.

When second partial clutch 12 is in a disengaged position, second contact plate 7 in turn is spaced apart from second clutch disk 5 and is out of frictional contact with second clutch disk 5, which causes second pressure plate 3 and second clutch disk 5 to be separated. Second actuating element 9 in turn is also rigidly designed, that is, as a rigid, dimensionally stable component.

Both first actuating element 8 and second actuating element 9 have radially outer region 17a, 17b in contact with respective contact plate 6, 7, in order to actuate/move the latter directly. With radially inner region 18a, 18b, which is located further inward radially than outer region 17a, 17b relative to clutch rotation axis 15, each of actuating elements 8, 9 is in contact with corresponding actuating bearing 19a, 19b, which actuating bearing 19a, 19b in turn is movable by means of slave cylinder 20, namely movable in the axial direction.

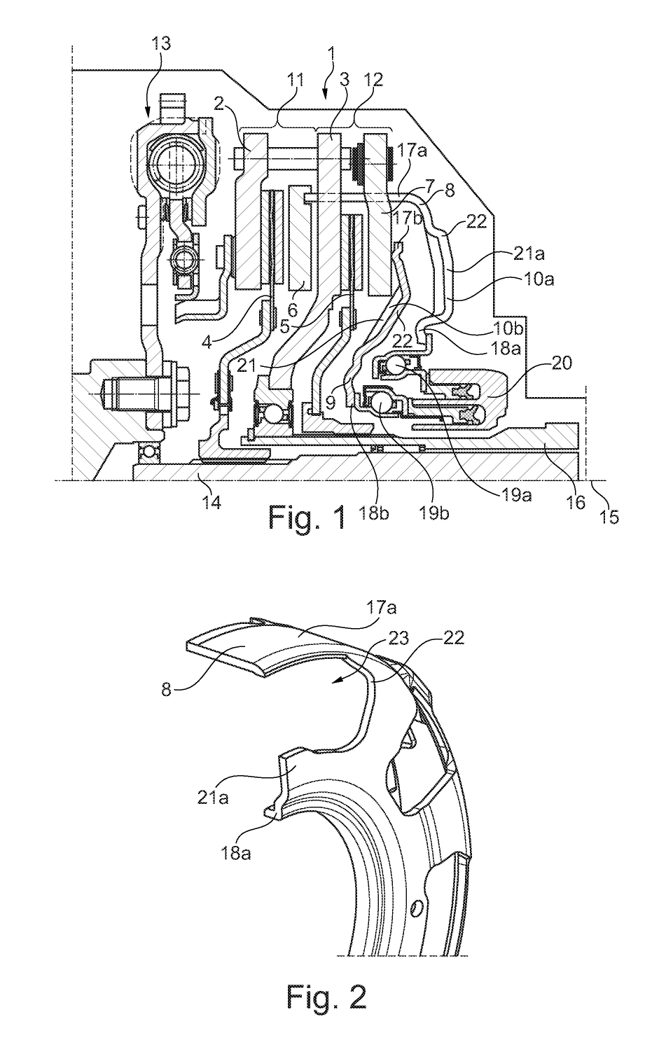

As can be seen especially well in connection with FIG. 2, on wall region 21a extending essentially in the radial direction, first actuating element 8 has at least one fluid diverting section 10, also provided below with reference label 10a in reference to first actuating element 8. In the interest of clarity, in the figure only one fluid diverting section 10a is configured, but there are a plurality of them, preferably at least three or four fluid diverting sections 10a positioned on first actuating element 8, which are distributed at uniform distances from one another around the circumference of first actuating element 8. Fluid diverting section 10a has diverting blade 22, also referred to as a scoop or vane geometry, which is formed by a local shaping in wall region 21a of first actuating element 8 in the axial direction. Diverting blade 22 is shaped by means of a cold-forming process. This is possible because first actuating element 8 is produced from a cold-formable metal material, namely a cold-formable steel material. Alternatively thereto, it is also possible to produce first actuating element 8 from a cold-formable aluminum alloy. Furthermore, first actuating element 8 is designed as a sheet metal part, which makes it possible to form first actuating element 8 exclusively by means of reshaping and stamping processes.

Diverting blade 22 acts together with opening 23 to divert/redirect/accelerate a cooling fluid into the interior of clutch 1. Opening 23 is positioned relative to diverting blade 22 in such a way that when first actuating element 8 rotates in a predetermined direction (viewed in FIG. 1 from out of the drawing plane) with the combustion engine operating, a cooling fluid, which is air in the case of dry-running friction clutch 1, is introduced in the axial direction from a side facing away from first contact plate 6 into the interior of friction clutch 1. Opening 23 in turn may preferably be produced by means of a stamping process. Diverting blade 22 and opening 23 thus make up fluid diverting section 10a. Diverting blade 22 is designed integrally with wall region 21 and, since the latter is designed integrally with the rest of first actuating element 8, is also designed integrally with first actuating element 8. Adjoining a side of wall region 21a of first actuating element 8 located radially outside is radially outer region 17a, which extends essentially in the axial direction. Adjoining a radially inner side of wall region 21a of first actuating element 8 is radially inner region 18a of first actuating element 8.

Second actuating element 9 in turn is designed corresponding to first actuating element 8. The statements made earlier therefore also apply to second actuating element 9. Only with regard to the geometric form of wall region 21b of radially outer region 17b and of radially inner region 18b, does second actuating element 9 differ from first actuating element 8.

Second actuating element 9 is designed as a cup-shaped load transfer plate, i.e., essentially pot-shaped. Wall region 21b of second actuating element 9 extends in the radial direction essentially obliquely outward, with radially outer region 17b being offset in the axial direction, toward wall region 21a of first actuating element 8, relative to radially inner region 18b. Second actuating element 9 has fluid diverting section 10, which is also provided below with reference label 10b in reference to second actuating element 9. Fluid diverting section 10b of second actuating element 9 is designed like the previously described fluid diverting section 10a of first actuating element 8. Second actuating element 9 too has a plurality of fluid diverting sections 10b, preferably at least three or at four, distributed uniformly around the circumference.

When friction clutch 1 is in the operating state, first actuating element 8 is positioned relative to second actuating element 9 in such a way that radially outer region 17a of first actuating element 8 extends around (i.e., radially outward of) second actuating element 9 in the radial direction. In addition, a center point of fluid diverting section 10a of first actuating element 8 seen in the radial direction is also positioned outside of a center point of fluid diverting section 10b of second actuating element 9 in the radial direction.

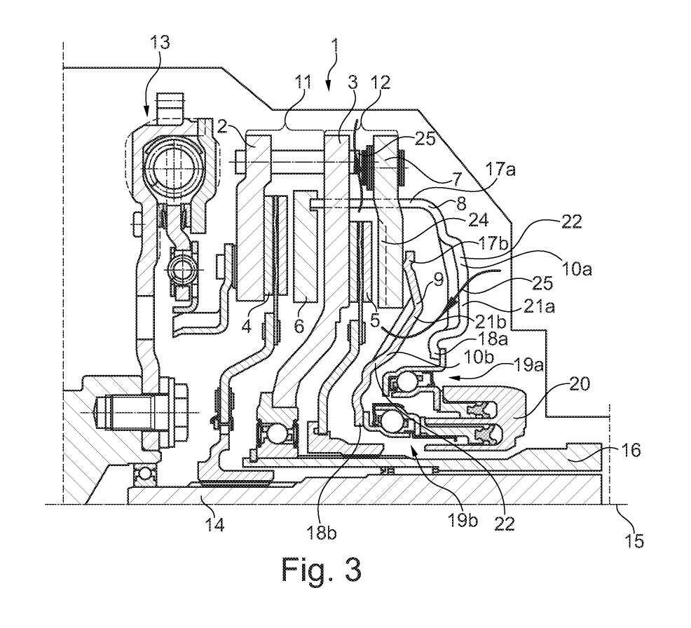

As can be seen again in connection with FIG. 3, according to another, second embodiment of friction clutch 1, a groove geometry is integrated into at least one of contact plates 6, 7. Such a groove geometry is preferably formed of at least one groove 24 extending ix) essentially in the radial direction. As an alternative to the design arranged exclusively in second contact plate 7, as depicted in FIG. 3, such a groove geometry is also formable in first contact plate 6 and/or in first pressure plate 2 and/or in second pressure plate 3. Such a groove geometry is also integratable into first clutch disk 4 and/or second clutch disk 5.

Such a groove geometry has groove 24 designed in such a way that, especially in the engaged position of respective partial clutch 11, 12, it is open to the surroundings both on a radially inner side and on a radially outer side, so that even in the engaged position, that is, with frictional surfaces in contact between plates 2, 3, 6, 7 on clutch disks 4, 5, cooling fluid can flow through and thereby actively cool the components. The stream of fluid/cooling fluid made possible by the groove geometry is identified in FIG. 3 by flow arrows 25.

Furthermore, pressure plates 2, 3 and contact plates 6, 7 are likewise all or partially/individually produced from a formable/cold-formable metal (steel or aluminum alloy), which makes the groove geometry especially simple to produce.

In addition, it is also possible to design additional second fluid diverting sections likewise as diverting blades and openings and to position these on one of pressure plates 2, 3, contact plates 6, 7, and/or clutch disks 4, 5, which would further improve the flow of the cooling fluid through the interior of friction clutch 1.

Furthermore it is also possible, in a system consisting of friction clutch 1 and a transmission bell housing, to attach/form a plurality of ribs in the bell housing that drive and/or divert the cooling fluid. These ribs then guide the cooling fluid specifically to fluid diverting sections 10a, 10b before the cooling fluid enters friction clutch 1.

In other words, in the present invention vane geometries 22 are integrated into cup-shaped load transfer plates 8, 9. This is simple to portray, since these components produced by stamping and reshaping have openings 23 from the outset. Ultimately, the region which is punched out anyway is left, and is merely designed for favorable flow. The circumstance that, in the solution described herein, the fan geometries (fluid diverting sections 10a, 10b) are components of rigid actuating elements 8, 9 (cup-shaped load transfer plates) results in a significant benefit when compared to what is known in the art because they can be rendered relatively simply, since the parent material, in contrast to that of a diaphragm spring, does not have to be heat-treated and can be optimized for the requirements of reshaping processes. Furthermore, the fact that the fan geometries (fluid diverting sections 10a, 10b) are located in rigid actuating elements 8, 9 (in contrast to swiveling diaphragm spring tongues as known in the art) provides for constant cross section conditions and their constant inflow, and thus reproducible flow-throughs.

In principle, both or only one cup-shaped load transfer plate 8, 9 may be provided with vanes 22 (of fluid diverting sections 10a, 10b). Vane geometry 22 makes sense in particular for the outer cup-shaped load transfer plate (first actuating element 8), which is in direct contact with the standing outside air. By shaping the floor of the transmission bell housing with radial ribs, an increase of the ventilation can be achieved.

Especially beneficially, the arrangement of vanes 22 in cup-shaped load transfer plates 8, 9 is combined with grooves 24 in thermal masses in the area of frictional contact/the friction surfaces. In this case, the groove geometry provides for a continuous flow through the frictional area, including when partial clutches 11, 12 are engaged. This groove geometry can be rendered especially advantageously in thermal masses made of sheet metal by reshaping, since in comparison to castings an additional milling expense is eliminated.

The combination with additional fan contours in counterplate/pressure plate 2, 3 is possible, and is beneficial for the active ventilation of the entire clutch 1.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE LABELS

1 friction clutch
2 pressure plate/first pressure plate
3 second pressure plate
4 clutch disk/first clutch disk
5 second clutch disk
6 contact plate/first contact plate
7 second contact plate
8 actuating element/first actuating element
9 second actuating element
10a fluid diverting section of the first actuating element
10b fluid diverting section of the second actuating element
11 first partial clutch
12 second partial clutch
13 torsional vibration damper
14 first transmission input shaft
15 clutch rotation axis
16 second transmission input shaft
17a radially outer region of the first actuating element
17b radially outer region of the second actuating element
18a radially inner region of the first actuating element
18b radially inner region of the second actuating element
19a actuating bearing of the first actuating element
19b actuating bearing of the second actuating element
20 slave cylinder
21a wall region of the first actuating element
21b wall region of the second actuating element
22 diverting blade
23 opening
24 groove
25 flow arrow

What is claimed is:

1-10. (canceled)

11. A friction clutch for a drivetrain of a motor vehicle, comprising:
a contact plate operatively arranged to displace relative to a pressure plate and a clutch disk to engage and disengage the clutch; and,
an actuating element non-rotatably connected to the contact plate and operatively arranged to displace the contact plate, the actuating element including at least one first fluid diverting section which, in an operating state of the friction clutch, introduces a cooling fluid into the interior of the friction clutch to cool the contact plate, pressure plate, and/or clutch disk, wherein the actuating element is designed as a rigid component.

12. The friction clutch as recited in claim 11, wherein the actuating element is designed as a cup-shaped load transfer plate.

13. The friction clutch as recited in claim 11, wherein the actuating element is produced from a cold-formable metal material.

14. The friction clutch as recited in claim 11, wherein the actuating element is implemented as a sheet metal part of a metal material.

15. The friction clutch as recited in claim 11, wherein the at least one first fluid diverting section comprises a diverting blade arranged as an integral part of the actuating element, wherein the diverting blade is produced by a reshaping process, preferably a cold-forming process and/or a stamping process.

16. The friction clutch as recited in claims 11, wherein at least the pressure plate or the contact plate comprises, in the area of a friction surface which is connected to the clutch disk in an engaged position, a groove geometry which is designed to distribute the cooling fluid.

17. The friction clutch as recited in claim 11, wherein at least the pressure plate or the contact plate has at least one second fluid diverting section which redirects the cooling fluid.

18. A system comprising the friction clutch as recited in claim 11 and a transmission bell housing, wherein the transmission bell housing is arranged adjacent to the friction clutch and comprises a plurality of ribs, the plurality of ribs operatively arranged to drive and/or divert the cooling fluid.

19. A friction clutch for a drivetrain of a motor vehicle, comprising:
a first contact plate operatively arranged to displace relative to a first pressure plate and a first clutch disk to engage and disengage a first partial clutch;
a second contact plate operatively arranged to displace relative to a second pressure plate and a second clutch disk to engage and disengage a second partial clutch;
a first actuating element non-rotatably connected to the first contact plate and operatively arranged to displace the first contact plate; and,
a second actuating element non-rotatably connected to the second contact plate and operatively arranged to displace the second contact plate.

20. The friction clutch as recited in claim 19, wherein the first actuating element comprises a first fluid diverting section and the second actuating element comprises a second fluid diverting section, wherein at least part of the first actuating element extends radially outside of the second actuating element.

21. The friction clutch as recited in claim 20, wherein the first and second actuating elements are designed as rigid components.
